(19) United States
(12) Patent Application Publication
(10) Pub. No.: US 2016/0217464 A1
(43) Pub. Date: Jul. 28, 2016

(54) MOBILE TRANSACTION DEVICES ENABLING UNIQUE IDENTIFIERS FOR FACILITATING CREDIT CHECKS

(71) Applicant: PAYPAL, INC., San Jose, CA (US)

(72) Inventors: Pawankumar Jajara, San Jose, CA (US); Ravi Kumar Singh, Cupertino, CA (US)

(21) Appl. No.: 14/984,364

(22) Filed: Dec. 30, 2015

Related U.S. Application Data
(60) Provisional application No. 62/108,386, filed on Jan. 27, 2015.

(51) Int. Cl. G06Q 20/38; G06Q 20/24; G06Q 20/32; G06Q 20/40

(52) U.S. Cl. CPC G06Q 20/3829; G06Q 20/4016; G06Q 20/24; G06Q 20/322

(57) ABSTRACT

When a user is requested to provide the user's social security number (SSN) or other personal information for conducting a credit/background check, the user may use a mobile app on the user's mobile device to display a unique identifier which is used in place of the SSN for processing the user's credit/risk analysis. The unique identifier is used as a protection layer on top of a user's SSN to reduce chances of identity fraud. In particular, an unique identifier (token) may be generated and issued to current payment account holders or new payment account holders when they sign up for payment accounts. When a merchant requires a customer's social security number for performing a credit or background check on the customer, the customer may simply provide the unique identifier and may be cleared to start using the merchant service without exposing the customer's SSN.

### CROSS REFERENCE TO RELATED APPLICATION

Pursuant to 35 U.S.C. §119(e), this application claims priority to the filing date of U.S. Provisional Patent Application Ser. No. 62/108,386, filed Jan. 27, 2015, which is incorporated by reference in its entirety.

### BACKGROUND

1. Field of the Invention

The present invention generally relates to mobile transaction devices, systems, and methods for facilitating unique identifiers used for credit or background checks.

2. Related Art

Identity theft has become a major problem in electronic commerce. For example, tens of millions of consumers suffer from identify fraud each year in the United States. One of the reasons identity fraud is so common is because social security numbers are printed on documents, provided online while signing up for services, entered on keyboards, and shared over various communication channels. All these mediums of sharing social security numbers expose them to unauthorized access. Further, there is a trust gap in the current market place for credit and risk background check services. The consumer data/reports provided sometimes are not accurate. In addition, there is not a single integrated credit/risk background service provider. Furthermore, the only way to trigger a background/credit check is by offering the social security number of the candidate, which exposes chances of identity theft. Therefore, there is a need for an improved system or method that facilitates the credit/risk background service that provides adequate security for customers' private information, such as the customers' social security numbers.

### BRIEF DESCRIPTION OF THE FIGURES

FIG. 1 is a block diagram of a networked system suitable for facilitating credit/risk background checks according to an embodiment.

FIG. 2A is a flowchart showing a process for generating unique identifiers for facilitating credit/risk background checks according to one embodiment.

FIG. 2B is a flowchart showing a process for implementing credit/risk background checks using unique identifiers according to one embodiment.

FIGS. 3a-3f are diagrams illustrating various user interfaces for facilitating credit/risk background checks according to one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, n unique identifier, such as a PayPal Unique Identifier (PPUID) is used as a protection layer on top of a user's social security number (SSN) to reduce chances of identity fraud. Note that the PPUID can be generalized to any unique identify used by a service provider for providing services discussed herein. In particular, an unique identifier (token) may be generated and issued to current payment account holders or new payment account holders when they sign up for payment accounts. Customers may provide their social security number when signing up for payment accounts.

The payment service provider may negotiate with merchants who need a SSN for doing background checks, credit checks and financial history for a customer when offering services. When a merchant requires a customer's social security number for performing a credit or background check on the customer, the customer may simply provide the unique identifier, e.g., PPUID, and may be cleared or authorized to start using the merchant service without exposing the customer's social security number.

In an embodiment, the unique identifier (PPUID) may be a wrapper on top of the SSN and may be changed periodically or as needed to prevent fraud, without affecting the original identity. In some embodiments, the PPUID may be for one time use and may expire after first time usage. In other embodiments, the PPUID may expire after a certain time period, such as an hour, a day, or other time period. This may reduce the likelihood of identity theft. The unique identifier may be encrypted and may include various private information of the user. As such, the private information of the user may be protected by encryption.

In an embodiment, the unique identifier may be generated as a barcode that is readable by a merchant's scanner. In other embodiments, the unique identifier may be a readable code with numbers, characters, and/or symbols that may be read by a person or be entered by the user in an online application. Customers may present or input their unique identifiers when requested for credit checks, background checks, criminal history, and financial history.

In an embodiment, the payment service provider may provide an identity check service, which is a consumer credit/risk background check service API available to merchants and third party applications. The identity check service may be used by merchants who desire to run credit/risk background checks for customers. The identity check service may include a decision engine (or algorithm) with inputs from major credit bureaus and customer spending behavior and financial history based on the payment service provider's transaction data analytics. The identity check service may work with both SSNs and the unique identifier (PPUID) making it flexible for users with or without unique identifiers. The identity check service may be used in various scenarios, including employers hiring new candidates with/without payment accounts, mobile carriers or broadband companies before issuing new smart phones, credit checks required for tenant screening, before issuing credit cards and/or bank accounts, before issuing mortgage or approving loans, or the like.

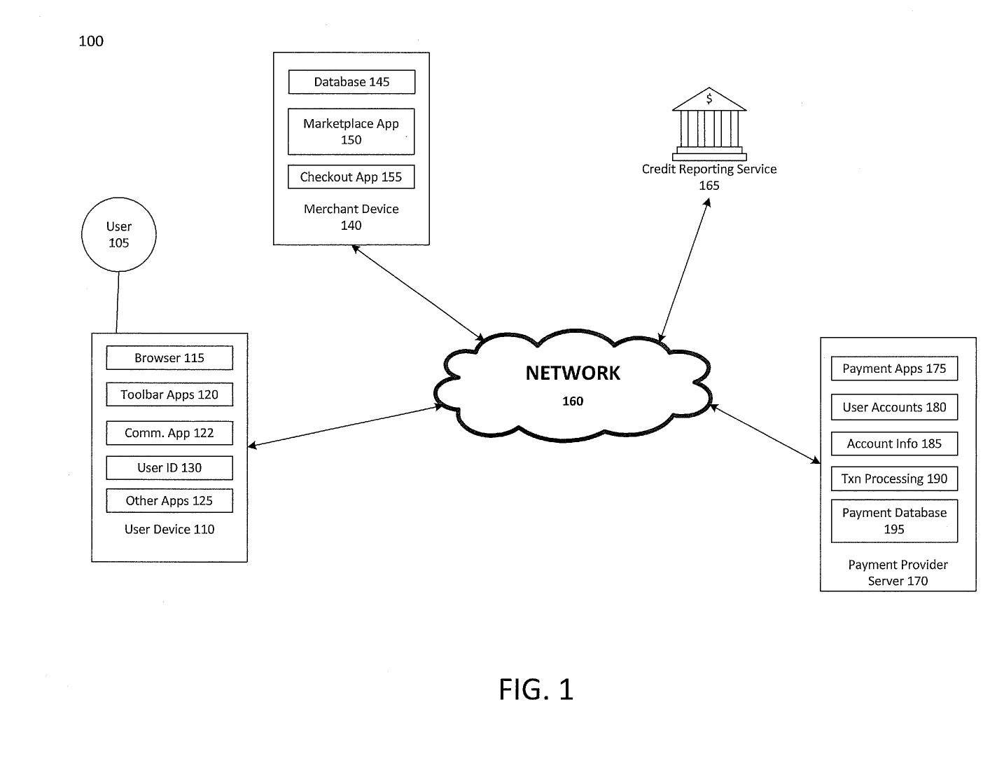

FIG. 1 is a block diagram of a networked system 100 suitable for implementing a process for facilitating credit and/or risk checks according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a credit reporting service 165, a merchant device 140, and a payment provider server 170 in communication over a network 160. A payment service provider, such as PayPal, Inc. of San Jose, Calif., may maintain the payment provider server 170. A user 105, such as a sender or consumer, utilizes user device 110 to perform a transaction using payment provider server 170. User 105 may utilize user device 110 to initiate a payment transaction, receive a transaction approval request, or reply to the request. Note that transaction, as used herein, refers to any suitable action performed using the user device, including credit/risk checks, payments, transfer of information, display of information, etc. For example, user 105 may utilize user device 110 to request a credit/risk check at a merchant. Although only one merchant server is shown, a plurality of merchant servers may be utilized if the user is purchasing products or services from multiple merchants.

User device 110, merchant device 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, wearable computing device, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications. In another example, a mobile payment app from the payment service provider may be installed at the user device 110. The mobile payment app may allow the user 105 to generate and display a unique identifier (PPUID) using the mobile payment app. The unique identifier may be presented or provided to merchants or entities who request the user 105's credit/background check.

Applications 125 may also include email, texting, voice and IM applications that allow user 105 to send and receive emails, calls, and texts through network 160, as well as applications that enable the user to communicate, transfer information, make payments, and otherwise utilize a digital wallet or account through the payment provider as discussed herein. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

Credit reporting service 165 may be operated by one or more credit reporting service providers, such as Equifax, Experian, TransUnion, or FICO. The credit reporting service 165 may monitor and keep track of consumers' credit histories, transaction histories and various credit or financial risk related information of consumers. Credit reporting service 165 may provide merchants/customers with reports of credit history or background checks upon request.

Merchant device 140 may be maintained, for example, by a merchant or seller offering various products and/or services. The merchant may have a physical point-of-sale (POS) storefront. The merchant may be a participating merchant who has a merchant account with the payment service provider. Merchant device 140 may be used for POS or online purchases and transactions. Generally, merchant device 140 may be maintained by anyone or any entity that receives money, which includes charities as well as banks and retailers. For example, a payment may be a donation to a charity or a deposit to a saving account. Merchant device 140 may include a database 145 identifying available products (including digital goods) and/or services (e.g., collectively referred to as items) which may be made available for viewing and purchase by user 105. Accordingly, merchant device 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

Merchant device 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, and the like.

In some embodiments, the merchant device 140 may be a mobile device or a POS device including an input device configured to receive a unique identifier of a customer for a credit/background check. For example, the input device may be a scanner configured scan a bar code or QR code associated with or corresponding to the unique identifier. In another example, the input device may be a keypad or a touch screen at which a customer/user may input the unique identifier for credit/background check. The merchant device 110 may communicate the unique identifier and a request for credit/background credentials to a payment service provider to obtain a credit/background report for a user/customer.

Payment provider server 170 may be maintained, for example, by an online payment service provider, which may provide payment between user 105 and the operator of merchant device 140. In this regard, payment provider server 170 includes one or more payment applications 175 which may be configured to interact with user device 110 and/or merchant device 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant device 140 on behalf of user 105 during a transaction with checkout application 155 to track and manage purchases made by users and which and when funding sources are used.

A transaction processing application 190, which may be part of payment application 175 or separate, may be configured to receive information from user device 110 and/or merchant device 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

The payment provider server 170 may include a database storing transaction history, purchase history, account history, and/or credit history of users/merchants. The information stored in the database may be used for analyzing user/merchant credit/background credentials. The payment provider server 170 may also retrieve credit reports from other credit reporting services and may incorporate various credit reports into the credit/background analysis.

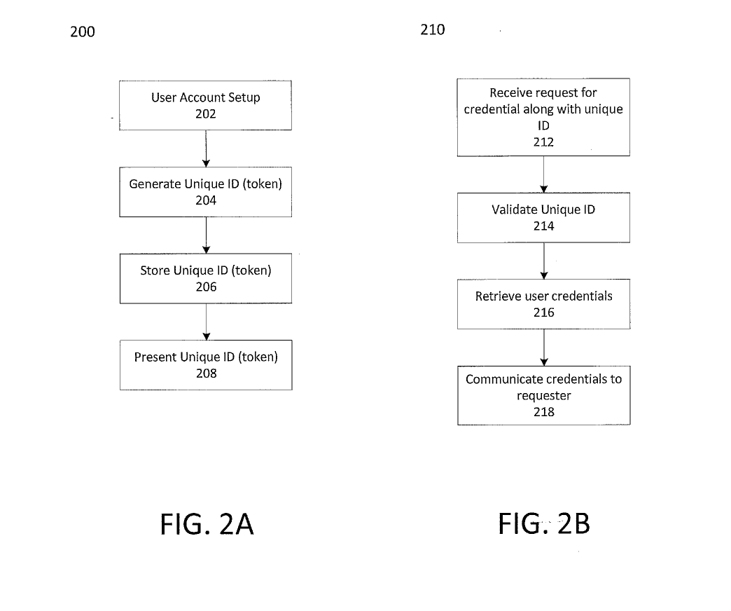

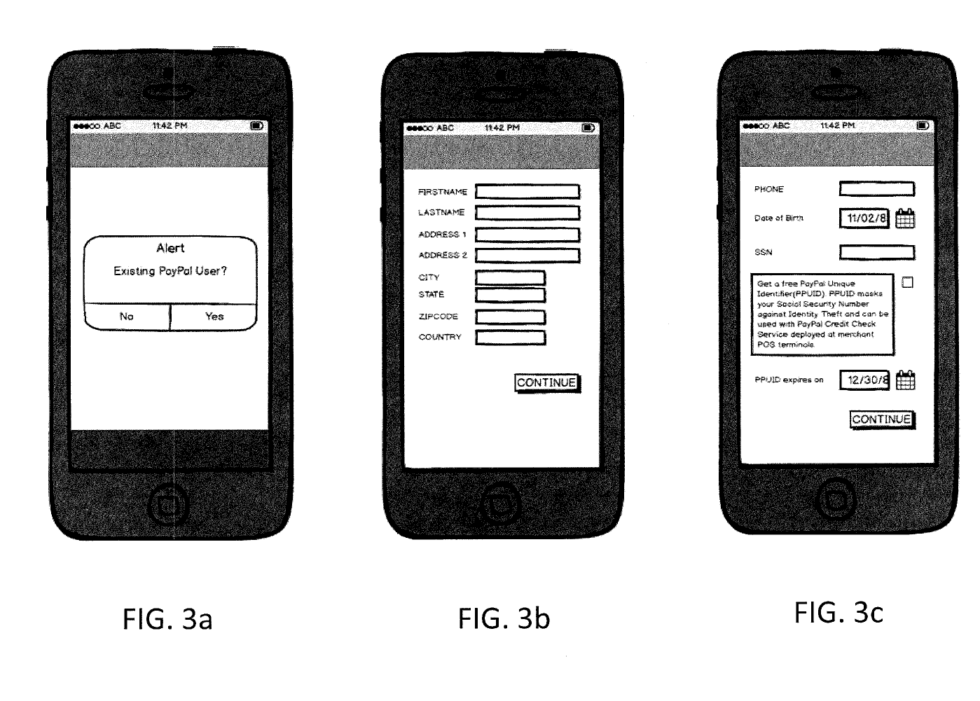

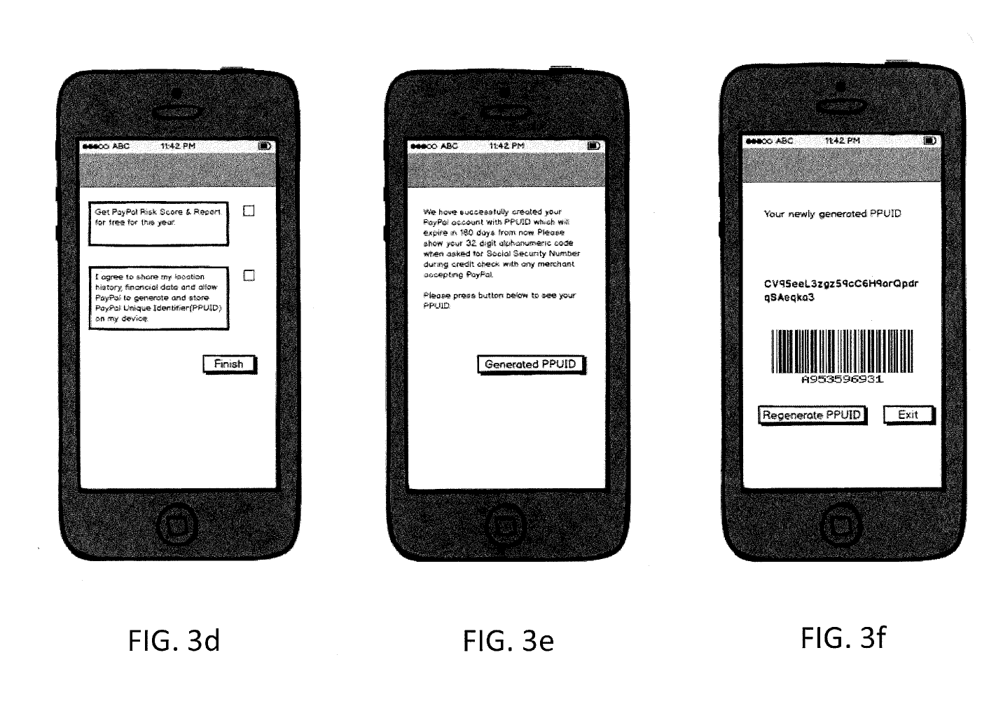

FIG. 2A is a flowchart showing a process 200 for generating unique identifiers for facilitating credit/risk background checks according to one embodiment. At step 202, the user 105 may set up or sign up for an account with the payment service provider. For example, the user 105 may activate/operate a mobile app at the user device 110 to connect to an API at the payment provider server 170 to sign up for a payment account. As shown in FIG. 3a, the mobile app at the user device 110 may display a choice for the user 105 to sign up for a payment account. The user 105 may then be requested by the mobile app to enter various personal and/or financial information, such as name, address, contact information, funding sources for the payment account, social security number, and the like. For example, as shown in FIGS. 3b and 3c, the mobile app at the user device 110 may display a user interface for the user 105 to enter various information, such as name, address, city, state, zip code, phone number, date of birth, social security number, and the like.

The mobile app also may allow the user 105 to select whether they would like to use a unique identifier (e.g., a PPUID) feature for identity theft protection. The unique identifier may be used instead of the user 105's personal/private information (e.g., SSN) at various merchants or point of sale locations for various purposes, including requests for credit/background checks. Thus, the user 105's personal/private information may be protected from being exposed or misused. The user 105 also may be allowed to set the expiration date of the unique identifier. Further, as shown in FIG. 3d, the user 105 may select to receive a free risk score and report. An option also may be provided for the user 105 to agree to allow the payment service provider to track the user 105's location history and financial data. If the user 105 chooses not to utilize the unique identifier option, the payment provider server 170 may proceed to create a payment account without generating a unique identifier for the user.

At step 204, a unique ID (token) for facilitating credit/risk assessment may be generated. For example, if the user 105 chooses to utilize the unique identifier option, the payment provider server 170 may generate a unique identifier (e.g., PPUID) for the user's payment account (e.g., via a True Risk Underwriting Secure Tokenator (TRUST)). The PPUID may be a 16 digit or a 32 digit alphanumeric identifier. In particular, the 16 or 32 digit alphanumeric identifier may have a certain convention with each digit indicating various information regarding the user 105 or the user's account, such as version of mobile payment application on the user device 110, user's month of birth, unique identifier or token expiration day, expiration month, user's birth year, random alphanumeric digits, user device type, device operating system, transaction type, offline payment enable flag, payment current code, portions of the social security number, and the like. Various information may be embedded in a particular order, format, and/or convention in the unique identifier (token) with random alphanumeric digits inserted among them.

For example, in a 16-digit unique identifier, the first 5 digits may be randomly generated numbers/characters, the 6^{th} digit may indicate a version of the user 105's mobile app, and the 7^{th} through 12^{th} digits may be portions of the user 105's SSN. Particular portions the SSN may be selected, such as the first three digits and the last four digits. The portions of the SSN may be arranged in a particular order and inserted in the unique identifier. The 13^{th} digit of the unique identifier may be designated for indicating the user 105's birth month, the 14^{th} digit of the unique identifier may be designated for indicating the unique identifier's expiration, the 15^{th} digit of the unique identifier may be another randomly generated alphanumeric character, and the 16^{th} digit of the unique identifier the user's birth day. Different size/format/convention of the unique identifier may be used as needed and changed periodically or randomly to improve security. For example, a 16 digit, 32 digit, or any number of digit may be used for the unique identifier, as needed. Further, the function and meaning of each digit of the unique identifier may be designated by the payment service provider and kept confidential. As such, the size/format/convention of the unique identifier may be kept confidential by the payment service provider and non-authorized entities may not be able to generate fake unique identifiers.

In some embodiments, the unique identifier may be encrypted for enhanced security. Various encryption techniques may be used to encrypt the unique identifier. For example, a public/private key encryption technique may be used. A private key maybe generated and stored at the payment provider sever 170 and a public key may be communicated to and a corresponding public key. The public key may be used to encrypt a unique identifier at the user device 140. The payment provider server 170 may then use the private key to decrypt the unique identifier later. Thus, the communication of unique identifier between the payment provider server 170 and the user device 140 may be secured.

If the unique identifier has an expiration date, the payment application may set the expiration date based on the user's selection or agreement. For example, the user 105 or the payment service provider may set the unique identifier to expire after a certain number of uses (expire after three uses) or after a time period (expire in one week). If the unique identifier does not have an expiration date, the mobile payment application may allow the unique identifier to be used or presented to merchants without expiration. If the unique identifier has an expiration or has certain use limits, the mobile payment application may restrict the user of the unique identifier according to the predetermined expiration or use limits. After the unique identifier is generated, as shown in FIG. 3e, the mobile payment app on the user device 110 may display a message indicating that the unique identifier (PPUID) has been generated for credit/background checks. An option (e.g., a button) also may be provided for displaying the unique identifier.

In some embodiments, the unique identifier (PPUID) may be generated by a payment application at the user device 110 without connecting to the payment provider server 170. As such, the user device 110 may generate the unique identifier without server side interaction. For example, after the initial registration process with the payment service provider, the user 105 may subsequently use the mobile payment app on the user device 110 to generate or refresh the unique identifier. In this case, the mobile payment app may include the functions and/or algorithm for generating or refreshing the unique identifier by itself, without having to connect to the payment provider server 170. For example, the public key stored at the user device 110 may be used to generate a new unique identifier. This may be useful when the user device 110 is at a location where network connection is weak or not available. The user 105 may still able to use the mobile payment app at the user device 110 to generate or refresh the unique identifier for credit/background checks.

At step 206, the unique ID (token) may be stored at the user device 110 or at the payment service provider 170 ready to be presented or used by the user 105 for credit/background checks. In some embodiments, the unique identifier may be periodically refreshed or regenerated. For example, the unique identifier may be refreshed every week. In an embodiment, the unique identifier may be refreshed/regenerated after a certain number of uses. In an embodiment, the unique identifier may be refreshed based on risk/security assessment. For example, if the user is traveling to a new location or to a less-secured location, the unique identifier may be refreshed/regenerated more frequently. In another example, when suspicious activities are detected at the user's account, such as multiple failed log-in attempts, detection of fake unique identifiers, and the like, the current unique identifier may automatically be suspended and a new unique identifier may be automatically generated.

At step 208, the unique ID (token) may be presented to merchants or other credit checking requesters to facilitate credit/risk assessment of the user 105. For example, when the user 105 is at a merchant and applying for a credit card or credit line, the merchant may request for the user 105's SSN and/or other personal information for conducting a credit/background check of the user 105. Instead of providing the merchant with the user 105's SSN or other personal information, the user 105 may represent the unique ID to the merchant for credit/background check. As shown in FIG. 3f, the user may 105 press on the “show PPUID” button, and the user device 110 may display the unique identifier, as shown in FIG. 3f. The alphanumeric unique identifier (PPUID) may be displayed including a scannable code, such as a bar code or a Quick Response (QR) code, that may be scanned or otherwise captured by a scanning device of the merchant device 140 of the merchant or entity requesting the user 105's SSN or personal information. The merchant or requesting entity may then send the unique identifier along with the request for a credit/background report of the user 105 to the payment service provider.

FIG. 2B is a flowchart showing a process 210 for implementing credit/risk background checks using unique identifiers according to one embodiment.

At step 212, a request for a user's credential may be received along with a unique ID (token) of the user. As noted above in step 208, when the user 105 is at a point of sale (either physical or virtual) that requires a credit or background check, such as at a merchant, a bank, a credit card company, a leasing office, a financial institute, a service website, a government entity, and the like, the user 105 may be requested to provide various personal and/or financial information including a social security number. In response, the user 105 may provide a unique identifier (e.g., scannable PPUID code) to the merchant or the entity. In some embodiments, the user 105 may input or enter the alphanumeric code of the unique identifier at the merchant's website or POS device. In an embodiment, the mobile payment app at the user device 110 may generate the unique identifier in real time in response to the user 105 requesting a new unique identifier on the mobile app. In another embodiment, the unique identifier may have been generated previously and stored in the mobile app ready to be used.

The merchant or the requesting entity may communicate the unique identifier along with a request for credit/background check on the user 105 to the payment provider server 170. In an embodiment, the merchant device 140 may be installed with a mobile merchant app including functions for scanning and communicating the unique identifier to the payment service provider. The request may include various information related to the purpose and type of credit/background check. For example, the request may include information on the identity of the merchant or requesting entity, purpose/reason for the credit/background check (e.g., new/increase credit line, new loan, new mobile phone account, job application, government security clearance, and the like), type of merchant business, particular area of interest, and the like. In other examples, the request may include the level of thoroughness. Merchants or requesting entities may pay more to obtain a more detailed/thorough credit risk analysis.

At step 214, the received unique ID (token) may be validated by the payment provider server. The payment provider server 170 may have an identity check engine, a token whitelisting service, a token decoder service, and a token validation service. The token whitelisting and the token decoder services are offered to the POS system of the merchant to ensure that the unique identifier (PPUID) token is not fraudulent. For example, the token decoder service may first decode the received unique identifier if the unique identifier is encoded or encrypted using a private key. If the unique identifier is not able to be decoded or decrypted, the unique identifier may be invalid or defective. In this case, the merchant or the requesting entity may be notified of the invalidity or defect.

If the unique identifier is decoded or decrypted, the token validation service may validate the unique identifier (PPUID token) against pre-defined rules, regular expressions, and other details from the account of the user. For example, the payment provider server 170 may check to make sure that the unique identifier is not expired or restricted from being used at the merchant. The payment provider server 170 also may check to make sure that the format and convention of the unique identifier matches those defined by the payment service provider. The information encoded in the unique identifier also may be checked to make sure they match the information in the user 105's account with the payment service provider. For example, the unique identifier may include other personal information of the user 105, such as location, birth date, SSN, and the like. Any discrepancies may be detected and used for authentication determination.

If the unique identifier (PPUID token) is not legitimate or valid, a message indicating that the unique identifier (PPUID token) has bad credential or has defect may be notified to the user 105 or the merchant. In some embodiments, if the unique identifier (PPUID token) is not valid because the unique identifier has expired, the process may allow the user 105 to refresh or generate a new unique identifier at the user device 110. If the unique identifier is found to be valid and legitimate, the payment provider server 170 may include a SSN mapper service that maps the unique identifier to the user's social security number associated with the unique identifier. The mapping process may be encrypted to provide security to the user's social security number.

At step 216, the user's credentials may be retrieved. The payment provider server 170 may use the social security number to obtain or retrieve credit reports from credit reporting services 165, such as Equifax, Experian, TransUnion, and/or FICO. Further, the payment provider server 170 also may have a risk score service that generates a risk score of the user 105 based on customer risk analysis, customer financial history, real time customer spending behavior, third party financial data, and third party employment data. A more comprehensive picture of the user 105's credit history and/or credit risk may be generated based on both the past and the present behaviors of the user 105. A risk score report then may be generated for the user 105 including information from both the third-party credit reporting services and the user 105's information available at the payment service provider. A lower risk score may indicate better customer confidence.

In some embodiments, the payment provider server 170 also may perform web presence analysis of the user 105. The user 105's online activities, such as online purchases, online transactions, social media network interactions, and the like, may be included in the web presence analysis. For example, the user 105's recent online postings may be analyzed to provide additional clues to the user 105's credit risk. The user 105 may post recently: “Free at last, just paid off my student loan.” Thus, the payment provider server 170 may note that a possible loan payment may have occurred recently to update the user 105's credit risk assessment. Other online activities, such as online spending history, may also be analyzed to provide additional clues to the user 105's credit risk. Accordingly, the payment provider server 170 may collect and consider various sources and aspects of the user 105 to provide a more comprehensive assessment of the user 105's credit risk.

In an embodiment, the different information sources, such as third party reporting services, web presence analysis, and the like, may be weighted differently for generating the risk score report. For example, if the requester is an online merchant and the risk report is for extending an online credit, the payment provider server 170 may weigh online transaction history more heavily for risk analysis. In another example, if the merchant is a bank and the user 105 is applying for a credit card, the payment provider server 170 may weigh the user 105's past credit history more heavily, such as the user 105's credit card payment history, loan payment history, and the like. Thus, the risk analysis may be customized based on the type of merchant or requesting entity and the purpose/reason for the credit/background check. In an embodiment, the merchant may select the type of risk analysis in the credit/background check request. At step 218, the user's credentials may be communicated to the merchant or the requester. The payment service provider may then communicate the risk score report of the user 105 to the merchant or the user 105. The merchant may then make decision on whether to continue the transaction or approve the credit application based on the report.

Accordingly, by utilizing the unique identifier (PPUID token) for credit or background checks, the user 105's private information, such as the user 105's social security number, may be protected from unauthorized exposure. In particular, the payment service provider may safeguard the social security number of the user 105. When the user 105 is requested to provide SSN or other personal information, the unique identifier may be used in place of the social security number for initiating credit checks. The payment service provider may act as the middle person between the user, the merchant, and third-party credit reporting services to facilitate credit and/or risk checks. By using the unique identifier (PPUID), the user's social security number is not exposed to merchants or other unknown entities. The unique identifier also may expire and/or encrypted to provide additional protection.

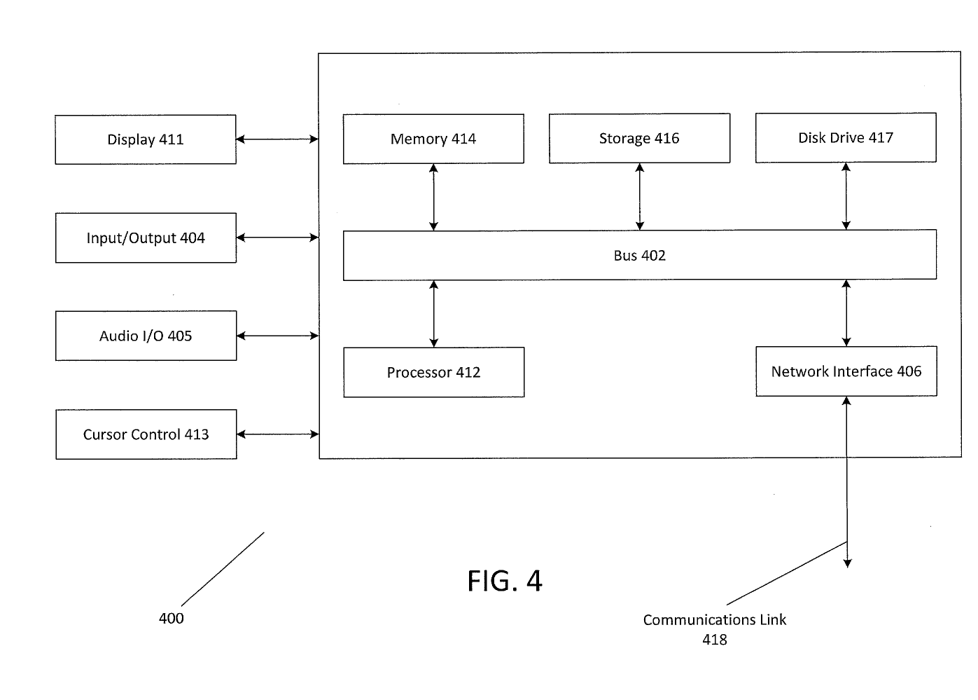

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, wearable computing device, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A mobile transaction device comprising:
a display device configured to present visual information;
a user input device configured to receive user instructions;
a non-transitory memory storing information about a user account of a user; and
one or more hardware processors coupled to the non-transitory memory and configured to read instructions from the non-transitory memory to cause the mobile transaction device to perform operations comprising:
receiving, by the user input device, a request from the user to provide an unique identifier for credit check;
retrieving or generating the unique identifier associated with the user via a mobile app, the unique identifier encoded with personal information of the user for credit check; and
presenting, by the display device, the unique identifier to the user via the mobile app.

2. The mobile transaction device of claim 1, wherein the unique identifier comprises a plurality of alphanumeric characters designated to present the personal information of the user based on a format or convention determine by a payment service provider.

3. The mobile transaction device of claim 2, wherein the personal information comprise one or more of a Social Security Number, a birth date, a resident address, an account identifier, and mobile device information.

4. The mobile transaction device of claim 1, wherein the unique identifier comprises randomly generated alphanumeric characters inserted at certain digits of the unique identifier to provide uniqueness to the unique identifier.

5. The mobile transaction device of claim 1, wherein the unique identifier is encrypted by a public key provided from a payment service provider.

6. The mobile transaction device of claim 1, wherein the operations further comprise generating the unique identifier via the mobile app without network connection to a payment provider server.

7. The mobile transaction device of claim 1, wherein the unique identifier has an expiration based on time or a number of usage.

8. The mobile transaction device of claim 1, wherein the unique identifier is presented in a form of a scannable Quick Response (QR) code or a bar code.

9. A system comprising:
a non-transitory memory storing a payment account of a user; and
one or more hardware processors coupled to the non-transitory memory and configured to read instructions from the non-transitory memory to cause the system to perform operations comprising:
receiving a request for a credit check for the user, the request including an unique identifier associated with the user;
mapping the unique identifier to a social security number of the user associated with the payment account;
retrieving a credit history of the user from a credit reporting service using the social security number;
generating a risk score report based on the credit history and user activities associated with the payment account; and
communicating the risk score report to the merchant device.

10. The system of claim 9, wherein the unique identifier is encoded with the social security number of the user.

11. The system of claim 9, wherein the unique identifier has an expiration after which the unique identifier is invalidated.

12. The system of claim 9, wherein the unique identifier is encoded with one or more of a personal information of the user and a financial information of the user.

13. The system of claim 9, wherein the operations further comprise:
validating the unique identifier based on a predetermined format or convention; and
communicating an error message to the user or a credit check requester when the unique identifier is not validated.

14. The system of claim 9, wherein the operations further comprise:
decrypting the unique identifier with a private key associated with the user; and
communicating an error message to the user or a credit check requester when the unique identifier is not able to be decrypted by the private key.

15. The system of claim 9, wherein the operations further comprise:
determining whether the unique identifier has expired due to time limit or usage limit; and
communicating an error message to the user or a credit check requester when the unique identifier has expired.

16. The system of claim 9, wherein the operations further comprise:
retrieving credit reports of the user from a plurality of credit reporting services;
retrieving transaction history of the user;
retrieving online activities of the user; and
analyzing the credit reports, the transaction history, and the online activities of the user to generate the risk score.

17. The system of claim 16, wherein the credit reports, the transaction history, and the online activities are weighed differently for generating the risk score based on a purpose and a type of credit check.

18. The system of claim 9, wherein the operations further comprise:
receiving a request from the user to generate a new unique identifier;
retrieving personal information of the user;
determining particular digits of the new unique identifier based on the personal information; and
inserting ransom alphanumeric characters into the new unique identifier.

19. The system of claim 18, wherein the operations further comprise:
generating a private key and a public key associated with the user; and
communicating the public key to a user device of the user for encrypting an unique identifier generated at the user device.

20. A non-transitory machine-readable medium having stored thereon machine-readable instructions executable to cause a machine to perform operations comprising:
receiving a request for a credit check for the user, the request including an unique identifier associated with the user;
mapping the unique identifier to a social security number of the user associated with the payment account;
retrieving a credit history of the user from a credit reporting service using the social security number;
generating a risk score report based on the credit history and user activities associated with the payment account; and
communicating the risk score report to the merchant device.
